(19) United States
(12) Patent Application Publication
(10) Pub. No.: US 2011/0082589 A1
(43) Pub. Date: Apr. 7, 2011

(54) CONTROL DEVICE FOR A MOTOR VEHICLE

(76) Inventors: Martin Witte, Ahaus (DE); Andreas Peschl, Velbert (DE)

(21) Appl. No.: 12/881,018

(22) Filed: Sep. 13, 2010

(30) Foreign Application Priority Data
Sep. 16, 2009 (DE) 10 2009 029 500.3

(51) Int. Cl. G05B 13/00; G06F 19/00

(52) U.S. Cl. 700/275; 702/57

(57) ABSTRACT

A control device for a motor vehicle, wherein the control device serves to monitor user access. The system has a piezo sensor which is arranged for pressure or touch detection by a user and connected to a pressure loaded area. A charging circuit is provided, which charges the piezo sensor until a previously specified voltage parameter is reached. A recording and analysis system transforms the voltage that is applied to the piezo sensor into digital parameters and records a series of transformed voltage parameters. A control system is connected to the piezo sensor with an activatable input, and activates the analysis system. A microcontroller is arranged in the control system, and a signal to the activatable input triggers an interrupt in the microcontroller.

### BACKGROUND OF THE INVENTION

The invention concerns an actuator system/a control device for a motor vehicle, wherein the control device serves to monitor user access. The control device has a piezo sensor, which is linked to a pressure loaded area which can be accessed by users to register pressure operation or touch operation.

Control devices for user access are arranged at various access points of a motor vehicle for many types of purposes. A user may initiate a switching process or other function of the motor vehicle, wherein the control devices in current vehicles often use electrical or electronic components in order to form at least one link in the operating chain. Control devices which operate purely on a mechanical basis are only rarely found in vehicles now. There are many types of control devices to register operating access. Some systems use simple contact switches; other applications, however, also use control devices with capacitive sensors or sensors utilizing the piezo effect.

When using the piezo effect in a sensor, suitable piezo-electrical materials (quartz or e.g. barium titanate) are utilized. Such materials demonstrate the so-called indirect Piezo effect which builds up an electrical voltage that can be sensed on the piece of material when the piece of material is formed. In other systems, piezo-active materials are used as oscillating crystals whose changes due to user access are registered and used as sensor signals.

In the motor vehicle sector, it is also known to combine piezo sensors with capacitive sensors in order to be able to detect both short-term operation and long-term operation. Capacitive sensors also make it possible to record the approach of a user, unlike piezo sensors. Such a combination of capacitive sensors and piezo sensors is known, for instance, in DE 10 2005 061 754 A1.

Piezo sensors have the advantage as compared to capacitive sensors that they are less dependent on environmental conditions such as dew or rain in the sensing area, and therefore provide more reliable signals. However, since the piezo signals are short, pulse-like signals, comprehensive use in control devices is not possible without the additional use of sensors to record long-term operation.

### SUMMARY OF THE INVENTION

The invention is therefore based on the task of providing an improved and simplified control device which records long term operation by a user in a particularly reliable manner.

This task is solved in accordance with the invention by a device with the attributes of patent claim 1 as well as a corresponding process with the attributes of patent claim 8.

The device in accordance with the invention of the initially stated nature is embodied by a charging circuit which is linked to the piezo sensor to charge it. The charging circuit can be used to charge the sensor until a specified voltage parameter is connected between the ends of the piezo.

Furthermore a detection and analysis system is connected to the piezo sensor; this transforms a voltage that is connected to the piezo sensor into digital parameters and is able to record a series of transformed voltage parameters at least in the short term. A control device is connected to the piezo sensor with an input that can be activated, and is able to activate the detection and analysis system.

The control device in accordance with the invention operates as follows:

If the piezo sensor is operated by an operator (e.g. pressure is applied to it), this causes a charge shift in the piezo sensor and a detectable voltage is generated at the sensor. If the operator continues to exert long term operation or pressure, this can be recorded in accordance with the invention, for the operation by a user never takes place with consistent pressure due to the constantly changing muscle tension, that is, contraction and relaxation. Accordingly, the voltage applied at the piezo sensor changes constantly, corresponding to the changes in muscle tension/pressure on the sensor.

In accordance with the invention, the control device is equipped with a charging device or charging circuit which can bring the piezo into a specified charging state in which a desired offset voltage is connected between its ends. This measure in accordance with the invention brings the advantage that both voltage elevations and voltage reductions around the offset voltage can be recorded without problems and submitted for analysis. The smallest movements of the user, which occur even if the user aims at calm handling, generate positive or negative charges in the piezo and cause voltage changes. An alternating current is generated around the desired offset parameter, this is easily accessible for analysis and signals that the operator is present. The sensitivity in this detection method can be adjusted via the charge amount that is applied to the piezo. If the piezo is e.g. charged to a lower charge (lower resulting voltage), the system is more sensitive than with a higher voltage (e.g. 5 Volt).

In accordance with the invention, it is not a single voltage parameter that is evaluated, but a series of several consecutive voltage parameters is recorded as a voltage progression and evaluated. Herein detection takes place at a pre-specified frequency, e.g. with a frequency of 1 kHz, and the voltage progressions are monitored throughout a time span from several milliseconds to several seconds. In this manner, erroneous operations (e.g. due to shocks or strikes to the sensor) can be differentiated from user operation and excluded. The signal progressions can be used to recognize interfering influences. E.g. unintended shocks (falling branches or contact of the parking vehicle with passersby) regularly show sharp voltage peaks with relatively smooth drops back down to their original levels, while user operation shows a strong alternating voltage curve due to the stated varying pressure intensity.

Using the determined voltage curve, the invention makes it possible to use the analysis system to differentiate the type of operation.

It applies to the use of the invention that any desired known processes can be used for signal analysis; in particular, the amplitude of the voltage variations as well as the frequency of the variations can be evaluated. Herein, for example, a simple Fourier analysis can be performed in order to determine characteristic voltage variation frequencies. It is known that tensed muscles, e.g. when operating a touch switch, show a so-called action tremor or activity tremor, that is, a tension related muscle twitch. Such muscle twitches can be filtered out of the voltage parameters, since it commonly shows frequencies of approx. 10-40 Hz. The presence of a definitive frequency share in this range can be used, for instance, to determine user operation.

The charging device can fundamentally continuously maintain the piezo at a desired offset voltage, however it can also be possible to activate using the control unit in order to adjust the offset voltage at the piezo only from time to time.

However the signal analysis can also be completed with evaluations of the release data of the piezo sensor, or even be replaced by them entirely. If the charging circuit is continuously operated and activated in that it maintains the charging state in order to obtain a desired voltage parameter at the piezo, the charge that has flowed can be used as a measure for the charge shifts in the piezo. By continuously operating the sensor, charging and discharging takes place alternately, so that the charging circuit must continuously regulate in order to draw the charge away from the piezo from time to time, and on the other hand, apply the charge to the piezo from time to time. An analysis of these charge parameters or voltage intensities and time durations required for charging can also be used to detect user operation.

The control device furthermore has an input which can be activated and which is linked to the piezo sensor. In accordance with the invention, the control device is activated at the input of the activatable control device when the piezo is first operated and placed in query mode by the resulting voltage pulse. The control device can now activate the analysis system/begin to activate it. The voltage therefore does not need to be continuously detected at the piezo, but only when the control device has been activated by a voltage pulse at the activatable input. Only then does the signal analysis of the voltage that is applied to the piezo commence. If the charging circuit is not continuously operated, the charging circuit is also previously activated by the control device in order to set the desired offset voltage at the piezo by charging. Following this, the detection and analysis system detects the voltage at the piezo with the desired frequency and the corresponding signal progression is recorded. This signal progression is transformed into digital values and examined for characteristic attributes. In particular, it can initially be examined whether an initial operating pulse has a width which lies within a parameter range that recognizes commencing user operation as valid (commonly e.g. 50-100 ms). The curve progression can also be analyzed further in order to detect continuing operation by the user.

By charging the piezo sensor in accordance with the invention, a control device is created, which permits the detection of long-term operation without further sensor components and solely with the use of a piezo sensor.

In a preferred embodiment of the control device, the control system has a microcontroller, wherein a signal can trigger an interrupt in the microcontroller at the activatable input.

The use of a microcontroller in the control device in accordance with the invention is advantageous, since commercially common microcontrollers generally already possess the inputs used by the invention. In particular, such a microcontroller has activatable inputs and can be programmed to activate the analysis system or perform analysis functions itself with a simple adaptation of the running software.

The microcontroller can also handle significant tasks of the charging circuit, or the charging circuit may be fully implemented in the microcontroller. In this manner, the microcontroller can therefore combine the control system, the charging circuit and the analysis system within itself.

In a further embodiment, the control system is also connected to the charging circuit in order to activate it to charge the piezo sensor.

It is advantageous when the charging circuit does not continuously charge the piezo sensor to a specified charging state, but only initiates this when the control system (e.g. the microcontroller) has been activated and an operating event is imminent at the sensor. Only then is the sensor briefly charged (e.g. to 50-150 mV) and is available with increased sensitivity for the analysis of both rising and falling voltages.

An output of the analysis system is preferably linked to the control system in order to transmit one or more voltage parameters to the control system.

If the analysis system on the one hand and the control system on the other hand is formed in several parts, the analysis system can provide the control system with the recorded voltage parameters in order to enable the control system to engage in further evaluations or activation, e.g. of the charging circuit. The voltage parameters can be used to detect operation on the one hand, and on the other hand, to activate the charging circuit so that a preceding charge state is maintained.

In a particularly preferred embodiment, the control systems and analysis systems are implemented within the same microcontroller. In this case, the two systems are inseparably connected, for instance as parts of a program executed on the microcontroller, which has both an analysis functionality and a control functionality.

In a further aspect of the invention, a process is suggested for detecting an operation of a control device on a motor vehicle; herein the control device has a piezo sensor which is arranged for pressure or touch operation by a user and linked to a pressure loaded area.

Significant steps of the process consist of monitoring a voltage that is applied to the piezo sensor, wherein an interrupt is triggered in a microcontroller when a specified voltage parameter is exceeded at the piezo sensor. In a reaction to the activation of the interrupt, the piezo voltage is detected; if the piezo voltage shows a signal progression with characteristic attributes, user operation is then detected. Such a signal progression may be analyzed e.g. in terms of the pulse width, the variation frequency or similar attributes.

Following this, in the event in which user operation is detected, a radio dialog is then initiated for access control in a reaction to the user operation, wherein communication takes place between the vehicle and an ID actuator that is carried by the user. Furthermore the piezo voltage is continuously detected, wherein a timewise signal progression of the voltage is digitalized and subjected to signal analysis, and an operating signal is output when the signal progression indicates long-term operation of the piezo sensor.

Using the process in accordance with the invention and the steps therein stated, access control, e.g. on the door handle of a motor vehicle, can be implemented in a comfortable manner. A user operates a control element, e.g. a sensing surface on a motor vehicle door handle, wherein the sensing surface is connected to a piezo sensor and transfers the detected pressure to this sensor. This occurring applied pressure activates a microcontroller which detects the piezo voltage that is applied to the sensor and records the pulse width of the voltage pulse that is formed. In the event that a characteristic pulse width is shown, the motor vehicle sends out an authorization telegram with characteristic data via sensing antennae. If an authorized ID actuator is located within the receiving area and responds to the corresponding telegram, an authorization message can be sent back to the motor vehicle by the ID actuator. The continued detection of the piezo voltage at the door handle verifies whether continuous operation of the switch is present (e.g. for more than 0.5 s), and the locking device on the respective door can be released depending on this.

### BRIEF DESCRIPTION OF THE DRAWINGS

The invention is now explained in further detail using the included diagram.

FIG. 1 shows characteristic voltage progressions at the piezo sensor.

FIG. 2 shows a schematic structure of the system in accordance with the invention.

### DETAILED DESCRIPTION OF THE INVENTION

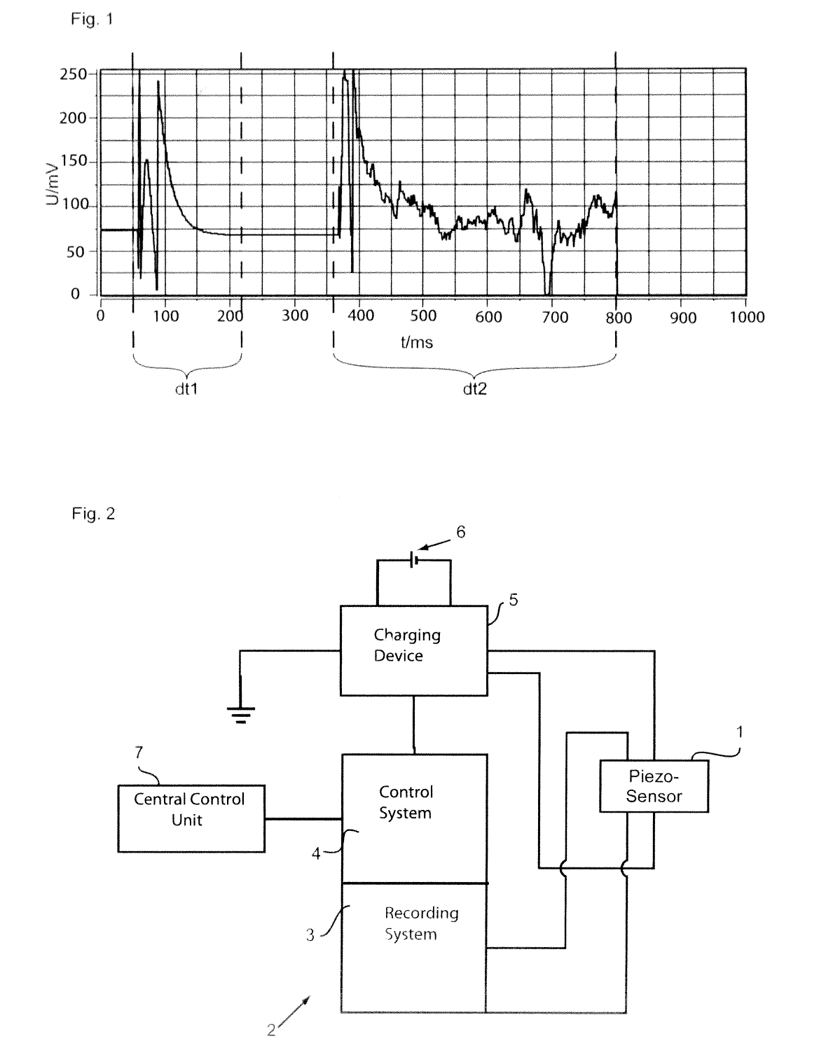

FIG. 1 shows a timewise progression of a voltage signal that is detected at the piezo sensor in a system in accordance with the invention. It is evident that the piezo sensor is initially charged—that is, to the time point t=0 ms, so that an offset voltage of 75 mV is applied between the sensor ends. In the timewise signal section dt1, a voltage signal progression which is generated e.g. by a shock, e.g. by an object striking the sensor (e.g. an umbrella or shopping cart) can be seen. After brief sharp peaks, the voltage that is applied to the piezo sensor returns to the offset voltage in a smooth curve, and reaches the same at the end of the time interval dt1 (at approx. 210 ms).

Contrary to this, in the time interval dt2, the voltage signal progression at the piezo sensor is shown in user operation with continuing pressure on the piezo sensor. It becomes clear that there is also a strong signal peak initially, wherein the charging device subsequently charges or discharges the piezo sensor in order to readjust to the offset voltage of 75 mV. The voltage varies around this offset voltage with strong alternating current and individual strong variations, which signals continuing operation by the user who continues to apply pressure. The voltage variations are particularly caused by the muscle tremors of the user.

During the entire time period, the charging device is active and attempts to readjust the charging state of the piezo so that the offset voltage is maintained.

It is immediately evident that the respective signal progressions can be differentiated with a simple signal analysis in a known manner, particularly when e.g. the white noise ratio or the variation frequency of the voltage are analyzed using known signal methods (e.g. the signal to white noise ratio (SNR) or Fourier analysis). In this manner, long term operation as it occurs in time period dt2 can be reliably differentiated from accidental operation or environmental influences as shown e.g. in dt1.

FIG. 2 schematically shows the control device in accordance with the invention. A piezo sensor 1 is connected to a microprocessor 2. Both the recording and analysis system 3 and the control system 4 are implemented in the microprocessor. The piezo sensor 1 is connected to an activatable input of the microprocessor 2 in order to be able to activate the recording system 3 and the control system 4. Further electrical and electronic components may be arranged within the connection route between the piezo sensor and the microprocessor, however they are not shown here in order to provide a clear overview. A person skilled in the arts can easily add these components within the limits of his expert knowledge for voltage determination or triggering an interrupt at the microprocessor.

The microprocessor 2 is linked to the charging device 5, which is supplied from a voltage source 6, via a control line. As described above, the microprocessor can also perform the duties of the charging device; in this case, the charging device 5, the control system 4 and the analysis system 3 would be implemented within a microprocessor; that is, they would be formed as one component. In this exemplary depiction, however, these functional components are shown separately in order to explain the functional principle in further detail. The charging device 5 can charge the piezo sensor to a desired charging state, wherein a target voltage is monitored at the piezo sensor. The start of the charging device can be initiated by the microprocessor via the control line. The charging device is, for instance, activated in order to maintain a previously specified voltage offset at the piezo sensor (e.g. 75 mV as in FIG. 1). For this purpose, the piezo sensor is charged or discharged, depending on the connected voltage. This regulation to a target parameter counteracts the voltage variation through operation of the piezo sensor by a user, so that the charging device repeatedly charges or discharges the piezo during long term user operation. The resulting varying or alternating voltage parameters are recorded by the microprocessor, particularly the recording and analysis systems. A central control unit 7 of the vehicle is furthermore linked to the microprocessor 2. If the microprocessor 2 detects a valid user operation of the piezo sensor 1, it can inform the central control unit about this, and the central control unit can accordingly trigger appropriate switching functions or communications with an ID actuator that is carried by the user.

It is evident that the regulation of the voltage parameter by the charging device should not take place more quickly than the evaluation of the piezo voltage in order to avoid falsifying the results. This applies in any case when the voltage of the piezo is used to evaluate an operation. If the charge that is shifted by the charging device is detected and used for evaluation, this limitation is less relevant.

Numerous complex variations are possible within the invention; in particular, complete and complex operation patterns of a piezo sensor can be detected, analyzed and evaluated, wherein various switching functions can be triggered depending on an operation pattern. Furthermore the choice of the target charge state of the piezo sensor can also be used to adjust the sensitivity of this sensor, since a higher connected offset voltage offers lower sensitivity to variations caused by form changes.

We claim:

1. Control device for a motor vehicle to monitor user access, with a piezo sensor which is arranged for pressure operation or touch operation by a user and linked to a pressure loaded area,
wherein
a charge circuit is provided which is connected for charging the piezo sensor, wherein the piezo sensor can be charged by the charging circuit until a specified voltage parameter is applied,
wherein a recording and analysis system is connected to the piezo sensor; this transforms a voltage that is connected to the piezo sensor into digital parameters and is able to record a series of transformed voltage parameters,
wherein a control device is connected to the piezo sensor via an activatable input, and
wherein the control device is able to activate the analysis system.

2. Control device in accordance with claim 1, wherein the control system possesses a microcontroller and a signal at the activatable input is able to trigger an interrupt in the microcontroller.

3. Control device in accordance with claim 1, wherein the control system is connected to the charging circuit in order to activate it to charge the piezo sensor.

4. Control device in accordance with claim 1, wherein an output of the analysis system is linked to the control system in order to transmit one or more voltage parameters to the control system.

5. Control device in accordance with claim 4, wherein the control system activates the charging circuit in dependence of the current voltage parameter.

6. Control device in accordance with claim 1, wherein the control system and the analysis system are implemented within the same microcontroller.

7. Control device in accordance with claim 1, wherein the control system and the charging circuit are implemented within the same microcontroller.

8. Control device in accordance with claim 1, wherein the control device is formed as part of the system for controlling access authorization for motor vehicles, wherein the control system is connected to a central control unit in the vehicle in order to initiate a radio dialog to control a user's access authorization in dependence of a succession of voltage parameters recorded at the piezo sensor.

9. Process to detect operation of a control device on a motor vehicle, wherein the control device possesses a piezo sensor which is arranged for pressure or touch operation by a user and linked to a pressure loaded area,
with the steps:
Monitoring a voltage that is connected to the piezo sensor, wherein an interrupt is triggered in a microcontroller when a previously specified voltage parameter is exceeded.
Detection of the piezo voltage, wherein a user operation is recognized when the piezo voltage shows a previously specified signal progression,
Initiation of a radio dialog for access control as a reaction to the user operation,
Continued detection of the piezo voltage, wherein a timewise signal progression is digitalized and subjected to signal analysis, and an operating signal is issued when the signal progression shows long-term operation of the piezo sensor.

10. Process in accordance with claim 9, wherein the piezo sensor is repeatedly or continuously charged before and during continued detection of the piezo voltage until a previously specified voltage parameter is reached.

11. Process in accordance with claim 9, wherein the piezo sensor is repeatedly or continuously discharged before and during continued detection of the piezo voltage until a previously specified voltage parameter is reached.

12. Process in accordance with claim 10, wherein a charging quantity that is required for charging or discharging is repeatedly detected and evaluated to detect continued operation.
